(19) United States
(12) Patent Application Publication
(10) Pub. No.: US 2005/0114780 A1
(43) Pub. Date: May 26, 2005

(54) Adapter card for television reception

(76) Inventor: Shlomo Turgeman, Ramat Efal (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/704,602

(22) Filed: Nov. 12, 2003

(51) Int. Cl. H04N 7/173

(52) U.S. Cl. 715/718; 725/151

(57) ABSTRACT

An adapter card for a personal computer (PC), including an I/O element connected to a bus interface adapted to interface with PC graphics display components, and a first interface module connectable to the I/O element and adapted to receive TV signals from a first TV system and transmit the TV signals for viewing on a PC display monitor, and a second interface module connectable to the I/O element and adapted to receive TV signals from a second TV system and transmit the TV signals for viewing on the PC display monitor.

### FIELD OF THE INVENTION

The present invention relates generally to receiving television broadcasts, such as but not limited to, on personal computers (PC), laptops, set-up boxes, and more specifically to an adapter card that modularly permits receiving television broadcasts from a variety of sources, such as but not limited to, terrestrial, cable or satellite.

### BACKGROUND OF THE INVENTION

Broadcast and/or interactive television may be distributed in analog or digital form over a variety of means, including but not limited to over the air, satellite systems, cable systems, also called Community Access Television (CATV) systems, coaxial-analog or digital and fiber-coax cable systems, ADSL (Asymmetrical Digital Subscriber Loop), and other wireless distribution systems.

Satellite communication has long been used to broadcast data to computers. In situations requiring the same data to be transmitted to multiple sites, satellite communication, which allows a single transmission of data to be received at multiple sites, can be more cost effective than terrestrial communication, which requires separate transmission to each site.

Cable television and satellite television services are generally provided through the use of conditional access technology enabling only authorized users to access the broadcast data is essential to ensure payment for the data. Conditional access is typically implemented by encrypting the broadcast data and providing the decryption keys only to authorized receivers. A set-top box (STB) converter converts signals from the cable or satellite television system into signals that can be displayed on a standard television.

Adapter cards are known that enable satellite reception without the need for an external satellite receiver. For example, U.S. Pat. Nos. 5,652,795 and 6,307,937 to Dillon, et al. describe an adapter card, for use in a computer, to provide conditional access by the computer to incoming data streams while maintaining the security of information by maintaining a listing of addresses corresponding to data streams which the computer is authorized to receive, receiving and determining the address of a frame, determining whether the frame address matches an address maintained in an Access Table, and processing and transmitting only those frames of data streams which the computer is authorized to receive.

Other adapter cards are known for viewing terrestrial television on a PC, while yet other adapter cards are known for viewing cable television on a PC.

### SUMMARY OF THE INVENTION

The present invention seeks to provide an adapter card that modularly permits receiving television broadcasts from a variety of sources, such as but not limited to, terrestrial, cable or satellite. The invention may be suited for receiving the TV signals at a PC, laptop, set-up box and the like. The present invention obviates the need for separate adapter cards for each type of broadcast. Rather a single adapter card may be purchased by the user and a module may be inserted in a slot in the adapter card for viewing terrestrial, cable or satellite (or other) broadcast. Different modules may be provided for viewing content from different providers, wherein each module is adapted for different conditional access criteria, depending on the content provider. Additionally or alternatively, the adapter card may include all of the modules for viewing all kinds of broadcasts.

### BRIEF DESCRIPTION OF THE DRAWINGS

The present invention will be understood and appreciated more fully from the following detailed description taken in conjunction with the drawing in which:

FIG. 1 is a simplified block diagram illustration of a PC with an adapter card that enables receiving television broadcasts from a variety of sources, such as but not limited to, terrestrial, cable or satellite, in accordance with an embodiment of the present invention; and

FIG. 2 is a simplified block diagram illustration of the adapter card, in accordance with an embodiment of the present invention

### DETAILED DESCRIPTION OF THE PREFERRED EMBODIMENT

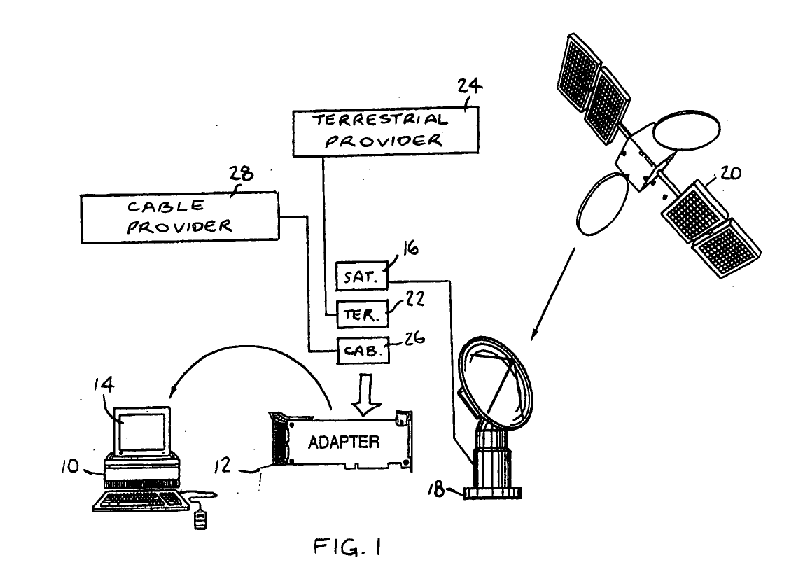

Reference is now made to FIG. 1, which illustrates a PC 10 with an adapter card 12 that enables receiving television broadcasts from a variety of sources, such as but not limited to, terrestrial, cable or satellite, in accordance with an embodiment of the present invention. The television content may be viewed on a PC display monitor 14, as illustrated, or other personal devices, such as but not limited to, a laptop, PDA and the like. The adapter card 12 may be used in conjunction with a set-up box for viewing the television content. It is emphasized that the invention is not limited to the illustrated PC or to any of the other personal devices mentioned.

For example, inserting a satellite module 16 in the adapter card 12 may enable receiving a satellite broadcast from a satellite 18 via an antenna receiver 20. Alternatively or additionally, inserting a terrestrial module 22 in the adapter card 12 may enable receiving a terrestrial broadcast from a terrestrial provider 24. Alternatively or additionally, inserting a cable module 26 in the adapter card 12 may enable receiving a cable broadcast from a cable provider 28. The terms cable and terrestrial are meant to encompass CATV systems, coaxial-analog or digital and fiber-coax cable systems, ADSL, and other wireless systems.

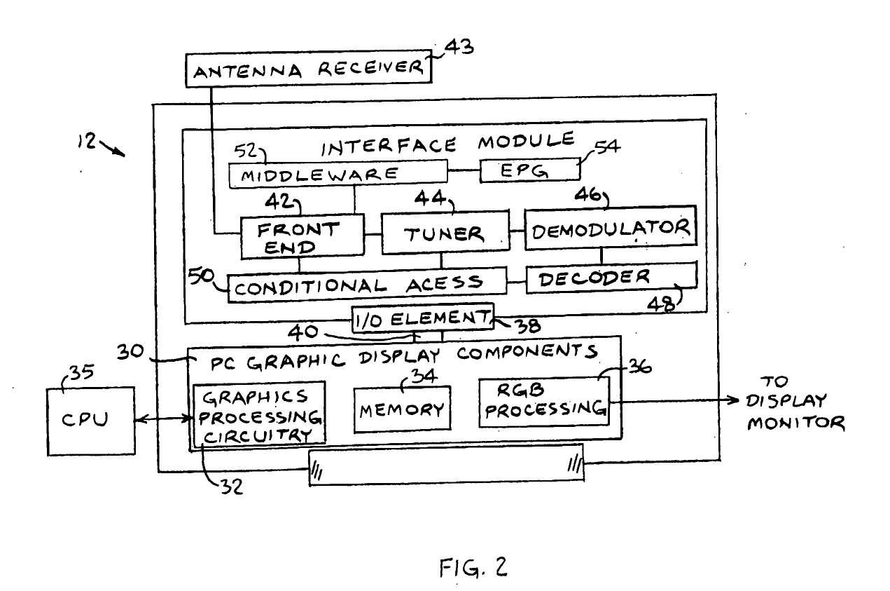

Reference is now made to FIG. 2. Adapter card 12 may comprise existing PC graphics display components, designated collectively by reference numeral 30. The PC graphics display components 30 may comprise without limitation, graphics processing circuitry 32, memory (e.g., RAM) 34, RGB processing circuitry 36 and the like. The PC graphics display components may be driven by a central processing unit 35 (CPU) of the PC in order to generate video signals that are sent to and shown on display monitor 14, e.g., a VGA monitor. This is an exemplary case for use with a PC, but it is understood that similar components may be provided for the other personal devices mentioned.

Each of the interface modules (in the illustrated example, satellite module 16, terrestrial module 22 or cable module 26) is designed to be inserted in an I/O (input/output) element 38 (e.g., a socket or slot) connected to a bus interface 40 that interfaces with the PC graphics display components 30. Thus, each interface module receives TV signals from the particular TV system (e.g., satellite, terrestrial or cable) in any format (e.g., NTSC or PAL, for example), and transmits them for viewing on display monitor 14 in any format (VGA or SVGA for example). The interface module may be in the size and format, for example, of a PCMCIA (Personal Computer Memory Card International Association) card, although the invention is not limited to this configuration.

Each of the interface modules may comprise a front-end sub-module 42 that communicates with an antenna receiver 43 for receiving signals from the particular TV broadcast provider. A tuner 44 may transmit data received by the front-end sub-module 42 to a demodulator 46, which may convert received data streams into digital form for decoding by a decoder 48. A conditional access sub-module 50 may provide the necessary decryption capability for viewing conditional access TV broadcasts (e.g., satellite, cable or other), for example. A middleware module 52 may be provided, which may be programmed to manage the communication between a database and the TV provider/content. An electronic program guide (EPG) module 54 may also be provided, to provide information about the TV programs and manage their selection by a viewer. The middleware module 52 and EPG module 54 may be different for different TV providers. Thus, a different interface module may be provided for the end-user for different conditional access criteria, depending on the content provider. Other components used in the art for TV reception, although not shown for the sake of clarity, may also be provided, as is well known to the skilled artisan, such as but not limited to, filters, digital-to-analog and/or analog-to-digital converters, modulators, memories, clocks and the like.

Thus in the present invention, a single adapter card may be purchased by the user and any of the interface modules may be inserted for viewing either terrestrial, cable or satellite (or other) broadcast

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. An adapter card for a personal computer (PC), comprising:
an input/output (I/O) element connected to a bus interface adapted to interface with PC graphics display components; and
a first interface module connectable to said I/O element and adapted to receive TV signals from a first TV system and transmit said TV signals for viewing on a PC display monitor, and a second interface module connectable to said I/O element and adapted to receive TV signals from a second TV system and transmit said TV signals for viewing on said PC display monitor.

2. The adapter card according to claim 1, wherein said interface modules are adapted to receive TV signals from at least one of a terrestrial, cable and satellite TV system.

3. The adapter card according to claim 1, further comprising PC graphics display components.

4. The adapter card according to claim 3, wherein said PC graphics display components comprise graphics processing circuitry, memory, and RGB processing circuitry.

5. The adapter card according to claim 1, wherein at least one of said interface modules comprises a front-end sub-module adapted to communicate with an antenna receiver for receiving signals from a TV broadcast provider.

6. The adapter card according to claim 5, wherein at least one of said interface modules comprises a tuner adapted to transmit data received by said front-end sub-module to a demodulator that converts received data streams into digital form for decoding by a decoder.

7. The adapter card according to claim 6, further comprising a conditional access sub-module that provides decryption capability for viewing a conditional access TV broadcast.

8. The adapter card according to claim 1, wherein at least one of said interface modules comprises a middleware module.

9. The adapter card according to claim 1, wherein at least one of said interface modules comprises an electronic program guide (EPG) module.
